(19) United States
(12) Patent Application Publication
(10) Pub. No.: US 2004/0145140 A1
(43) Pub. Date: Jul. 29, 2004

(54) Twist car

(76) Inventor: Amos Chen, Taichung (TW)

Correspondence Address: CHARLES E. BAXLEY, ESQUIRE, Hart, Baxley, Daniels & Holton, 5 Fl., 59 John Street, New York, NY, 10038, US

(21) Appl. No.: 10/354,816

(22) Filed: Jan. 29, 2003

(51) Int. Cl. B62M 1/00

(52) U.S. Cl. 280/87.01

(57) ABSTRACT

A twist car includes a body having a hole defined therethrough. A revolving axle is rotatably mounted to a front portion of the body by extending a first end through the hole in the body. A steering wheel is mounted to the first end of the revolving axle and located over the body of the car. A front wheels set includes a balance block, two small wheels and two rolling members that is fixed to a first end of the revolving axle and located underside of the body of the twist car. Two rear wheels are defined underside of the rear portion of the body of the twist car.

### BACKGROUND OF THE INVENTION

1. Field of the Invention

The present invention relates to a twist car, and more particularly, to a twist car is defined with a plurality of rolling members for preventing it from tumbling down.

2. Description of the Related Prior Arts

A conventional twist car is shown in FIGS. 1-2, which comprises a body 11, a first rear wheel 12, a second rear wheel 13, a revolving axle 14 and a balance wheel set 15. The balance wheel set 15 includes a swinging arm 151, a first balance wheel 152 and a second balance wheel 153. A support bracket 16 is defined at the bottom of the body 11 whence the revolving axle 14 extending out, the support bracket 16 synchronously swings with the swinging arm 151, which horizontally stretches in a direction opposite to the two balance wheels 152, 153 of the balance wheel set 15 and then turns downward, close to the ground at an end of the support bracket 16 a small rolling member 161 is located. Although such kind of twist car has been commonly used in nowadays, there are still some shortcomings will result in tumbling down and need to be improved.

For easy understanding, small circles represent for parts. The support bracket 16 is not allowed to touch the ground in order to achieve a smooth movement and easy turn of the twist car (just as shown in FIG. 1), furthermore, the car will swing left and right so as to move back and forth, which means the centroid of the twist car is changed by the oscillation of the balance wheel set 15.

As shown in FIG. 3, when the twist car is swung towards right, the operator on the car will incline his body let the center of gravity towards right too in order to balance his body, in case of moving improperly the body 11 of the twist car will slant to right, as a result, the support bracket 16 is forced to touch the ground, in this case, the centroid A of the body 11 is cooperatively supported by the support bracket 16, the first balance wheel 152 and the first rear wheel 12, which is in conformity with the centroid B of the triangle formed by the support bracket 16, the first balance wheel 152 and the first rear wheel 12. Obviously, the centroid A of the twist car has deviated much from its original position C (whence lies the centroid of the triangle formed by the revolving axle 14, the first rear wheel 12 and the second rear wheel 13), From this we can conclude that the body 11 of the twist car possibly tumbles right down in case of moving right, and vice versa, it possibly tumbles left down in case of moving left.

The present invention has arisen to mitigate and/or obviate the afore-described disadvantages of the conventional twist car.

### SUMMARY OF THE INVENTION

In accordance with one aspect of the present invention, there is provided a twist car that includes a body having a hole defined therethrough and a revolving axle is pivotably mounted to a front portion of the body by extending a first end through the hole in the body. A steering wheel is mounted to a second end of the revolving axle and located over the body of the car. A front wheels set including a block, two small wheels and two rolling members is fixed to the first end of the revolving axle and located underside of the body of the twist car. Two rear wheels are defined underside of the rear portion of the body.

The primary object of the present invention is to provide a twist car having a plurality of rolling members defined thereof for preventing the twist car from tumbling down.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an elevational view of a conventional twist car.

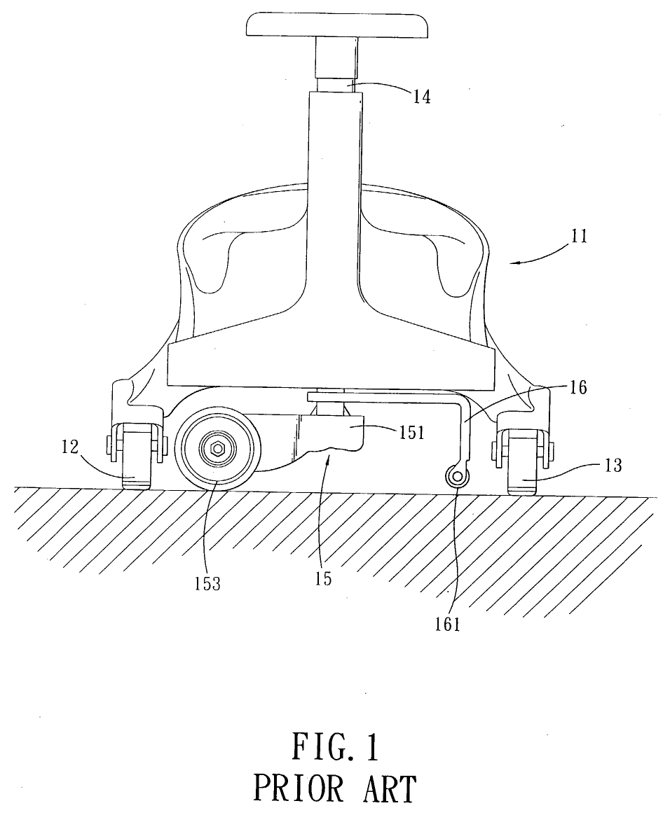

FIG. 2 is a schematic plan view of the conventional twist car.

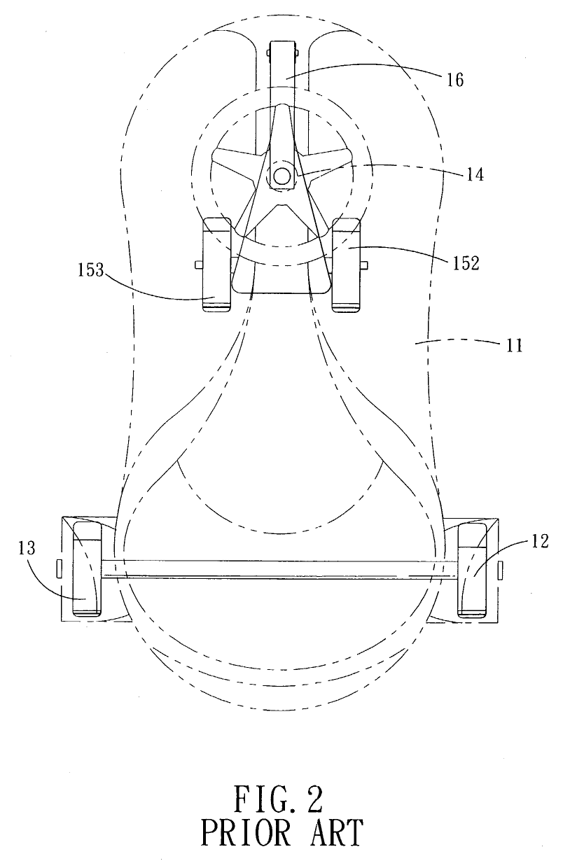

FIG. 3 is an illustrative view of showing the changes of centroid of the conventional twist car when it is swung to right.

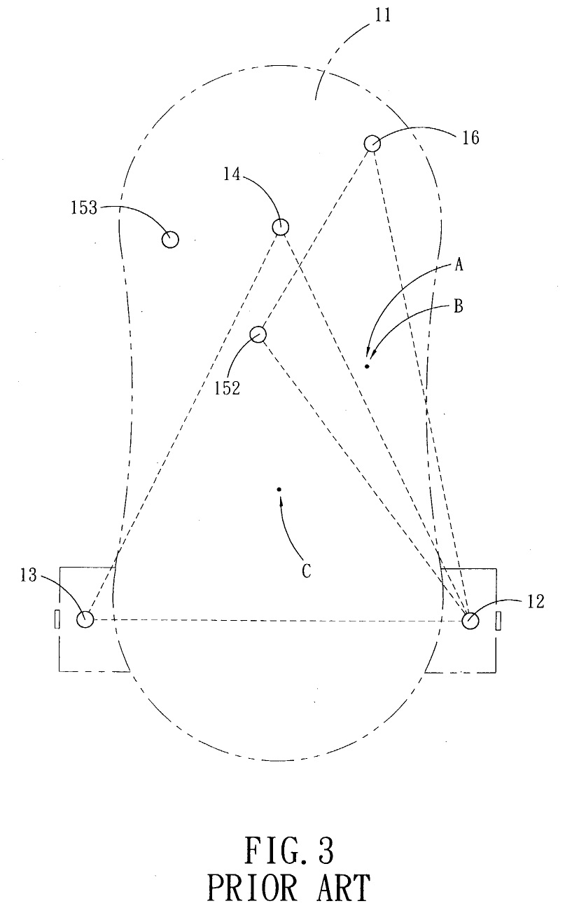

FIG. 4 is an exploded view of a twist car in accordance with the present invention.

FIG. 5 is a side view of a twist car in accordance with the present invention.

FIG. 6 is a schematic plan view of the twist car in accordance with the present invention.

FIG. 7 is an illustrative view of showing the changes of centroid of the twist car in accordance with the present invention when it is swung to right.

### DETAILED DESCRIPTION OF THE PREFERRED EMBODIMENT

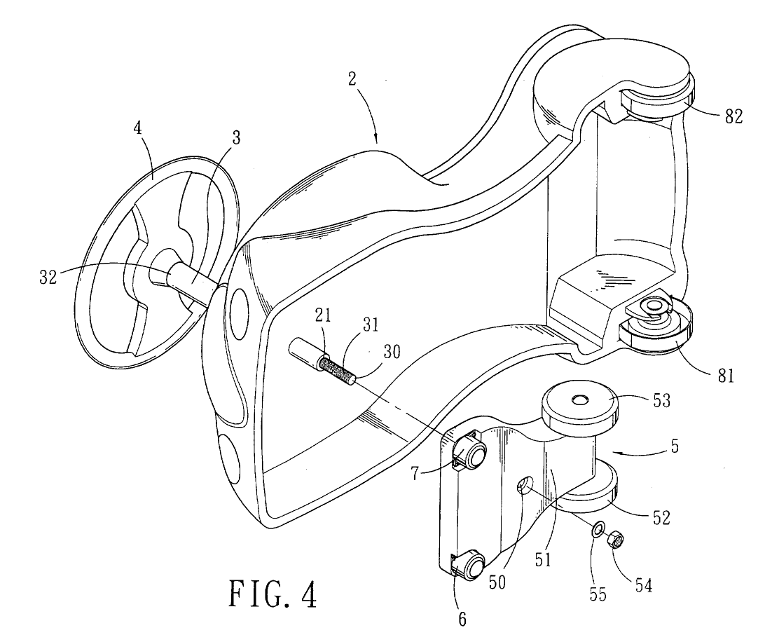

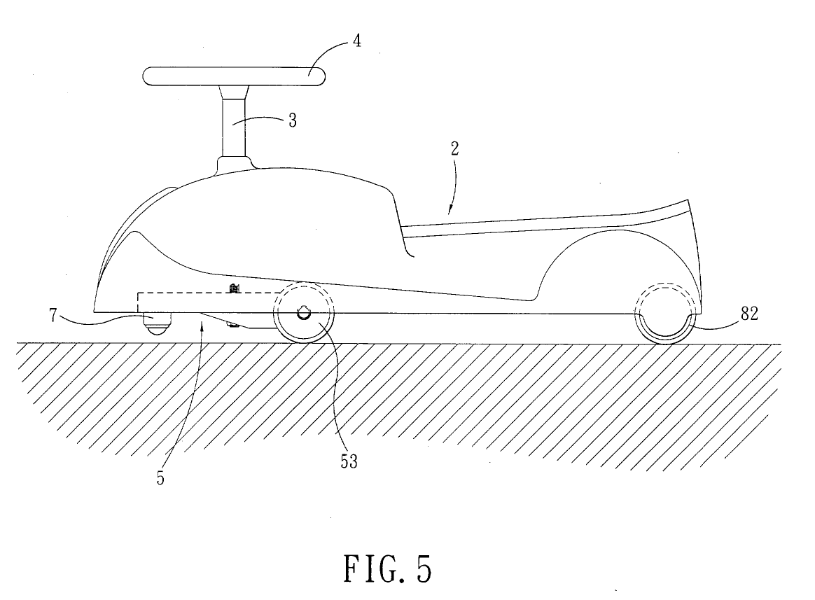

Referring to the FIGS. 4 to 5, a twist car of the present invention comprises a body 2, a revolving axle 3, a steering wheel 4, a front wheels set 5, a plurality of rolling members (here a first rolling member 6 and a second rolling member 7 are taken as examples) and a plurality of rear wheels (here are two rear wheels 81,82 taken as examples).

The body 2 of the twist car is designed for an operator mounting thereon. A hole 21 is located on the front portion of the body 2.

The revolving axle 3 is rotatably mounted to the front portion of the body 2 by extending a first end 30 through the hole 21 in the body 2. The revolving axle 3 has a threaded section 31 adjacent to the first end 30 thereof.

The steering wheel 4 is fixed to a second end 32 of the revolving axle 3 and is located over the body 2 of the twist car. An operator rotates the steering wheel 4 which will drive the revolving axle 3 to rotate.

The front wheels set 5 is located underside of the body 2 of the cart, which includes a balance block 51 having two wheels 52,53 pivotably defined thereof. The balance block 51 has a hole 50 defined therethrough and the threaded section 31 of the revolving axle 3 extends through the hole 50 for engaging threadedly with a screw nut 54. A washer 55 is mounted to the threaded section 31 of the revolving axle 3 and located between the balance block 51 and the screw nut 54. Thus, the front wheels set 5 can synchronously rotate with the revolving axle 3 and the steering wheel 4.

Each of the rear wheels 81,82 is rotatably located under the bottom of the rear portion of the body 2.

The first rolling member 6 and the second rolling member 7 are specially fixed to the balance block 51 of the front wheels set 5, (the rolling members may be wheels or universal rolling balls or the likes, here we take universal rolling balls as example), and the first rolling member 6, the second rolling member 7 and the two wheels 52,53 are defined around the edge of the balance block 51 with equally space-apart. The first and second rolling member 6,7 are symmetrically located (which means the first rolling member 6 is located on the right side of the body 2 of the car while the rolling member 7 on the left), thus, the balance block 51 has four supporting points. The two rear wheels 81,82 and the two wheels 52,53 on the balance block 51 will touch the ground after the body 2 of the twist car is laid on the ground while the first and second rolling member 6,7 are suspended a little distance apart from the ground without touching it. (just as shown in FIG. 5)

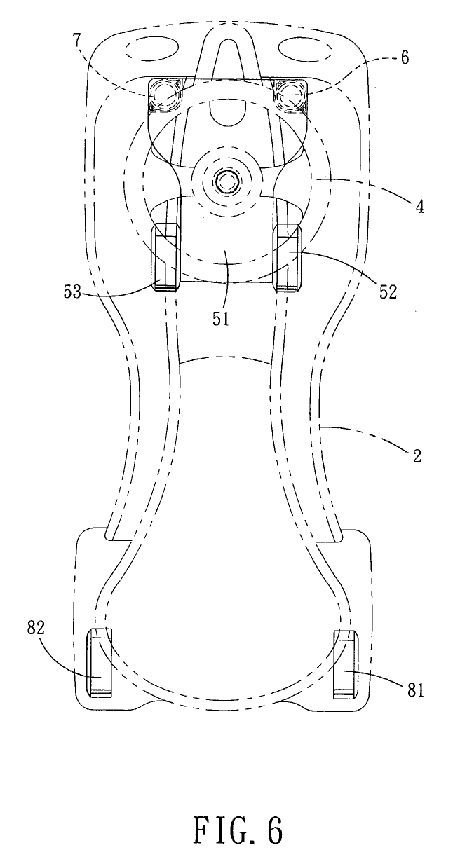

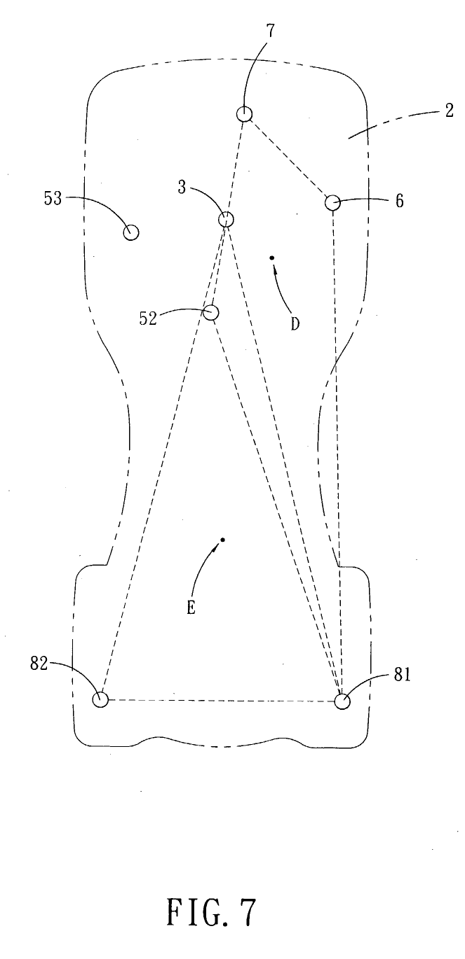

Referring further to the FIGS. 6 to 7, for easy understanding, the parts of the twist car are respectively represented by the small circles. When the twist car is swung towards the rear wheel 81 (that is the right side of the body 2), the operator on the car will incline his body let the center of gravity towards right to balance the body 2 of the car, in case of moving improperly the body 2 of the car will slant to right, as a result, the first and second rolling member 6,7 are forced to touch the ground, in this case, the body 2 is cooperatively supported by the first and second rolling member 6,7, the wheel 52 and the rear wheel 81, and the centroid D of the body 2 lies within the quadrangle formed by the first and second rolling member 6,7 the wheel 52 and the rear wheel 81. It is easy to find that the centroid D of the body 2 of the twist car doesn't deviate much from its original position E when the car is swung to right (whence lies the centroid of the quadrangle formed by the revolving axle 3, the two rear wheels 81 and 82), From this we can conclude that the body 2 of the twist car can be prevented form tumbling right down in case of moving right, and vice versa, it also can be prevented from tumbling left down in case of moving left. Further, the twist car will be supported by the four supporting points wherever it swings towards and accordingly can be prevented from tumbling down.

While we have shown and described various embodiments in accordance with the present invention, it should be clear to those skilled in the art that further embodiment may be made without departing from the scope of the present invention.

What is claimed is:

1. A twist car comprising:
a body having a hole defined therethrough;
a revolving axle is rotatably mounted to a front portion of the body by extending a first end through the hole in the body, the revolving axle having a threaded section defined adjacent to the first end thereof;
a steering wheel mounted to a second end of the revolving axle located over the body of the twist car;
a front wheels set located underside of the body of the car having a balance block defined with two wheels, the balance block having a hole defined therethrough and the threaded section of the revolving axle extending through the hole for engaging threadedly with a screw nut for allowing the front wheels set to synchronously swing with the steering wheel;
two rear wheels respectively defined underside of the rear portion of the body of the twist car;
a plurality of rolling members fixed to the balance block of the front wheels set, and the rolling members and the two wheels defined around the edge of the balance block with equally space-apart.

2. The twist car as claimed in claim 1, wherein the rolling members have two.

3. The twist car as claimed in claim 1, wherein the rolling members are wheels.

4. The twist car as claimed in claim 1, wherein the rolling members are universal rolling balls.
